(19) United States
(12) Patent Application Publication
(10) Pub. No.: US 2025/0069116 A1
(43) Pub. Date: Feb. 27, 2025

(54) AUTOMATIC INTELLIGENT SERVICE REQUEST MANAGEMENT METHOD AND APPARATUS

(71) Applicant: YAHOO ASSETS LLC, New York, NY (US)

(72) Inventors: Oren Shlomo SOMEKH, Kfar-Netter (IL); Eliran ABUTBUL, Haifa (IL); Ariel RAVIV, Haifa (IL); Zubair SHEIKH, Haifa (IL); Raissa NATAF, Haifa (IL); Emilien Pouradier-Duteil, Brooklyn, NY (US)

(21) Appl. No.: 18/452,911

(22) Filed: Aug. 21, 2023

(51) Int. Cl. H04L 43/16; H04L 67/63

(52) U.S. Cl. CPC G06Q 30/0254; G06Q 30/0241; G06Q 30/0275; H04L 67/63

(57) ABSTRACT

Techniques for intelligently managing service requests using a service request outcome prediction and a dynamically determined probability threshold are disclosed. In one embodiment, a computer-implemented method is disclosed comprising receiving a request for service directed to an online service provider, determining a feature vector for the received service request, the feature vector determination comprising identifying information associated with the request and a response of the service provider, the feature vector being based on the identified information, analyzing the received request using a trained outcome prediction model and the feature vector, and determining a win probability based on the analysis, the win probability indicating a likelihood of a predefined outcome in connection with the service request and the service provider's response, making a request throttling determination based on the win probability and a threshold probability, and managing the service request based on the request throttling determination.

### FIELD OF THE DISCLOSURE

The present disclosure relates to improvements to online service request systems and specifically to improvements in the managing inbound service requests.

### BACKGROUND

An online service provider can receive billions of requests for service (e.g., requests for content) on a daily basis. Each request entails operational costs, including consumption of computing resources, to provide a response to a service request. Typically, only a small percentage of the service requests yield a beneficial return, e.g., positive user engagement, publication of requested content, revenue-bearing event, etc., to the service provider. Additionally, a service provider's system has limited computing resources and may not have sufficient resources to respond to all of the service requests.

### SUMMARY

The present disclosure provides novel systems and methods for intelligently managing service requests using a service request outcome prediction and a dynamically determined probability threshold.

Presently, an online service provider uses system resources to respond to each received service request without regard to the outcome. An online service provider can receive millions of requests for service in any given time frame. While each request entails operational costs for the service provider, including consumption of computing resources, to provide a response to a service request, typically only a small percentage of the service requests yield a beneficial outcome, e.g., user engagement, revenue-bearing event, etc., to the service provider. Even if a service provider's system has sufficient capacity to handle, or respond to, all of the requests received, it is beneficial to have an ability to respond to only those service requests that are likely to yield some beneficial outcome to the service provider. As such, the service provider can respond to those service requests that are likely to result in users engaging in the service provider's website, online services, etc., for example. Armed with information indicating the likelihood of a beneficial outcome, the service provider can choose to focus on those service requests that are likely to yield a beneficial outcome and to throttle (e.g., ignore, limit, etc.) other service requests.

In accordance with embodiments of the present application, disclosed systems and methods use a machine learning (ML) model, also referred to as an outcome prediction model, trained on a corpus of training data comprising unthrottled service request traffic to determine an outcome prediction, or win probability (or probability of success), indicating a likelihood, or probability, that, if responded to, a service request made to a service provider results in a certain, or predefined, outcome, or event. The outcome can be predefined by the service provider. The outcome can be one that is beneficial for the service provider, such as and without limitation positive user engagement (e.g., with the response), publication of content included in the response, etc. Additionally, the disclosed systems and methods can dynamically determine a threshold probability that can be used in analyzing a service request to determine whether or not to throttle the service request.

Win probability is one illustrative example of an outcome prediction metric, or measure, that can be used in connection with the disclosed systems and methods. Another example of a metric that can be used in determining whether or not to throttle service requests is predicted revenue. It should be apparent that any metric, e.g., a metric associated with a desired, outcome can be used.

The service request analysis can comprise a comparison of a service request's win probability, determined using the model with the threshold probability to determine whether or not to throttle the service request. By way of a non-limiting example, a service request with a win probability that satisfies (e.g., is greater than or equal to) the threshold probability is not throttled, while a service request with a probability of success that fails (e.g., is less than) the threshold probability is throttled. In accordance with one or more embodiments, a service request with a win probability that satisfies the probability threshold can go on to be processed by the service provider, while a service request with a win probability that fails the probability threshold can be throttled. In accordance with one or more embodiments, a throttled service request may not be processed by the service provider, or the service request can be queued for processing after a number of service requests having win probabilities that satisfy threshold probability.

According to some embodiments, the disclosed systems and methods first generate a training dataset using unthrottled service request traffic representing past negative and positive service request outcomes. An instance included in the training dataset can comprise feature data corresponding to a service request and labeling data reflective of an outcome of the service request—e.g., whether the service request resulted in a certain outcome. In accordance with one or more embodiments, the training dataset can be used to train an ML model, or outcome prediction model, to generate a win probability for a service request given input comprising a set of features representative of the service request. In accordance with one or more embodiments, the trained model can be updated using feedback including an additional (e.g., new) corpus of service request traffic.

The disclosed systems and methods then analyze a received service request using the trained outcome prediction model. A feature vector can be generated for the received service request and the generated feature vector can be used as input to the trained outcome prediction model. The outcome prediction model can use the input to generate a win probability given the input.

The disclosed systems and methods can then make a throttling determination using the service request's win probability and a threshold probability. The throttling determination can be based on whether or not the service request's win probability satisfies the threshold probability. The throttling determination made in connection with a service request can be used to manage the service request. In accordance with one or more embodiments, a service request with a win probability satisfying the threshold probability can cause the service provider to not throttle (e.g., the service provider's system generates a response to the service request). Alternatively, a service request with a generated probability failing the threshold probability can cause a service provider to throttle the service request, such that the service provider's system does not process the service request or it queues the service request for later processing.

In accordance with one or more embodiments, the threshold probability used in making the throttling determination can be dynamically determined, or adjusted, using historical data comprising the win probabilities determined for previously-processed service requests. By way of a non-limiting example, the historical win probability data can be used to determine a probability distribution that can then be used to incrementally train, or adjust, the probability threshold using the probability threshold and a predetermined percentile corresponding to a predefined percentage of service requests to be throttled. The input distribution can vary over time. An initial (e.g., predetermined) value can be used as a current value for the threshold probability. The probability threshold can adjust over time in accordance with temporal changes in the input distribution. In accordance with one or more embodiments, the input distribution can be determined using the probabilities determined for incoming service requests in a current time frame. The value of the threshold probability can be determined using a given (e.g., current) input distribution and the predetermined percentile that corresponds to a that a desired (e.g., predefined) percentage of the service requests are processed and not throttled (or throttled and not processed).

In accordance with one or more embodiments, an online percentage estimator (OPE) can be used to determine the input distribution and percentile values which can be used to determine, or adjust, the probability threshold.

In accordance with one or more embodiments, the disclosed systems and methods can be used in connection with providing content to online users and the service requests can be requests for content. By way of a non-limiting example, the service provider can be a supply-side-platform (SSP) service provider that receives requests for advertising content from requesters (e.g., content publishers). In accordance with one or more embodiments, the disclosed systems and methods can be used to determine which incoming service requests for content are processed by the SSP.

While embodiments of the present disclosure are discussed in connection with an SSP and managing requests for content (e.g., advertising content), it should be apparent that the disclosed systems and methods can be used with any online service, including an online service where requests entail operation costs and an identified metric can be predicted regarding these requests.

It should be apparent that the disclosed systems and methods can be used by any number of different types of service providers. The content publishers making service requests to an SSP can themselves be receiving service requests. By way of a non-limiting example, a content provider can be a website provider and the service requests can be from online users accessing the website and its web page content. The disclosed systems and methods can be used by the content provider to determine which service requests received from the online users are processed by the content provider's system. Other non-limiting examples of service providers include ecommerce service providers,

It will be recognized from the disclosure herein that embodiments of the instant disclosure provide improvements to a number of technology areas, for example those related to systems and processes that handle or process online service requests, such as and without limitation, content generation and delivery to users over the internet, media rendering or recommendation platforms, electronic social networking platforms, ecommerce platforms and the like. The disclosed systems and methods can effectuate increased speed and efficiency in the ways that service providers handle service requests based on predicted outcome, thereby minimizing operational costs and focusing computing resources to those service requests from requesters/users that are likely to yield a certain (e.g., beneficial, successful, etc.) outcome, as the disclosed systems and methods, inter alia, provide a probability of a predefined outcome occurring with each service request, which can be used by the service provider to determine whether or not to process, of fulfill, them, thus improving a service provider's opportunities for focusing resources toward responding to online service requests from online users that are likely to result in beneficial, successful outcomes in connection with its users.

In accordance with one or more embodiments, a method is disclosed which includes receiving, at a computing device, a request for service directed to an online service provider; determining, via the computing device, a feature vector for the received service request, the feature vector determination comprising identifying information associated with the request and a response of the service provider, the feature vector being based on the request and response information; analyzing, via the computing device, the received request using a trained outcome prediction model and the feature vector, and determining a win probability based on the analysis. the win probability indicating a likelihood of a predefined outcome in connection with the service request and the service provider's response; making, via the computing device, request throttling determination based on the win probability and a threshold probability; and managing, via the computing device, the service request in connection with the service provider based on the request throttling determination.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method for automatically intelligently managing service requests.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a schematic block diagram illustrating components of an exemplary system in accordance with embodiments of the present disclosure;

FIG. 4 is a flowchart illustrating steps performed in accordance with some embodiments of the present disclosure;

FIG. 5 is a schematic diagram illustrating application of an expression determined using quantile regression to incrementally train a threshold probability in accordance with some embodiments of the present disclosure; and

FIG. 6 provides an exemplary illustration of a CDF of win probabilities that can be maintained using a t-Digest in accordance with one or more embodiments of the present disclosure;

FIG. 7 provides an illustration of adding a win probability to a cluster in a cumulative distribution function in connection with the t-Digest approach in accordance with one or more embodiments of the present disclosure;

FIG. 8 provides an example illustrating a quantile determination using a t-Digest in accordance with one or more embodiments of the present disclosure;

FIG. 9 provides an exemplary example of a technology platform involving advertising content service requests intelligently managed in accordance with embodiments of the present disclosure;

FIG. 10 provides an exemplary example in which request management engine 300 can be used to manage service requests in accordance with one or more embodiments of the present disclosure;

FIG. 11 provides an exemplary example of response vector generation in accordance with one or more embodiments of the present disclosure;

FIG. 12 provides an exemplary example of latent factor (LF) service request vector generation in accordance with one or more embodiments of the present disclosure;

FIG. 13 provides another example of combining LF feature vectors having inter-vector feature dependencies and feature independence in accordance with one or more embodiments of the present disclosure;

FIG. 14 provides an exemplary example of intelligently managing requests based on a win probability and threshold probability in accordance with one or more embodiments of the present disclosure; and

FIG. 15 is a block diagram illustrating the architecture of an exemplary hardware device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a simple smart phone. phablet or tablet may include a numeric keypad or a display of limited functionality, such as a monochrome liquid crystal display (LCD) for displaying text. In contrast, however, as another example, a web-enabled client device may include a high resolution screen, one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like.

A client device may include or may execute a variety of possible applications, such as a client software application enabling communication with other devices, such as communicating one or more messages, such as via email, for example Yahoo!® Mail, short message service (SMS), or multimedia message service (MMS), for example Yahoo! Messenger®, including via a network, such as a social network, including, for example, Tumblr®, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing or displaying various forms of content, including locally stored or streamed video, or games (such as fantasy sports leagues). The foregoing is provided to illustrate that claimed subject matter is intended to include a wide range of possible features or capabilities.

The detailed description provided herein is not intended as an extensive or detailed discussion of known concepts, and as such, details that are known generally to those of ordinary skill in the relevant art may have been omitted or may be handled in summary fashion.

The principles described herein may be embodied in many different forms. By way of background, online service providers can provide service to an entity (e.g., end users, other service providers, etc.) that communicates a request for service to the service provider via an electronic communications network, such as the internet. The search request can be a search request, a recommendation request, an ecommerce request, a content request, etc.

Presently, an online service provider uses system resources to respond to each received service request without regard to the outcome. An online service provider can receive millions of requests for service in any given time frame. While each request entails operational costs for the service provider, including consumption of computing resources, to provide a response to a service request, typically only a small percentage of the service requests yield a beneficial outcome, e.g., user engagement, revenue-bearing event, etc., to the service provider. Even if a service provider's system has sufficient capacity to handle, or respond to, all of the requests received, it is beneficial to have an ability to respond to only those service requests that are likely to yield some beneficial outcome to the service provider. As such, the service provider can respond to those service requests that are likely to result in users engaging in the service provider's website, online services, etc., for example.

Armed with information indicating the likelihood of a beneficial outcome, the service provider can choose to focus on those service requests that are likely to yield a beneficial outcome and to throttle (e.g., ignore, limit, etc.) other service requests.

As such, the instant disclosure provides a novel solution addressing the immediate demand for an automated system, application and/or platform that can be used to throttle incoming service requests based on a predicted outcome determination indicating, for each service request, a likelihood, or probability, that, if responded to, a service request made to a service provider results in a certain, or predefined, outcome, or event. In accordance with one or more embodiments, the throttling can result in a service provider prioritizing processing of queued service requests in accordance with their corresponding predicted outcome determinations. Alternatively, in some cases, a service provider can elect to forego processing a service request altogether.

The present disclosure provides novel systems and methods for automatic service request outcome prediction and commensurate service request throttling in accordance with predicted outcome. In accordance with embodiments of the present application, disclosed systems and methods use a machine learning (ML) model, also referred to as a success prediction model, trained on a corpus of training data comprising unthrottled service request traffic to determine a likelihood, or probability, that a service request made to a service provider results in a certain outcome, which is also referred to as an event. The outcome can be predefined by the service provider. The outcome can be one that is beneficial for the service provider.

While embodiments of the present disclosure are discussed in connection with a success prediction model trained to predict a probability that a publisher presents a winning ad returned from an SSP, it should be apparent that a success prediction model can be trained to predict any outcome, such as and without limitation predicted revenue. It should be apparent that any metric, e.g., a metric associated with a desired outcome can be used and that the success prediction model described in connection with disclosed embodiments can be used to make a prediction in connection with any metric.

Additionally, the disclosed systems and methods can dynamically determine a threshold probability that can be used in analyzing a service request to determine whether to process the service request. The service request analysis can comprise a comparison of a service request's probability of success, or win probability, determined using the model with the threshold probability to determine whether or not to throttle the service request. By way of a non-limiting example, a service request with a probability of success that satisfies (e.g., greater than or equal to) the threshold probability is not throttled, while a service request with a probability of success that fails (e.g., less than) the threshold probability is throttled. In accordance with one or more embodiments, a service request with a probability of success that satisfies the probability threshold can go on to be processed by the service provider, while a service request that fails the probability threshold can be throttled such that it is not processed by the service provider.

Win probability is one illustrative example of an outcome prediction metric, or measure, that can be used in connection with the disclosed systems and methods. Another example of a metric that can be used in determining whether or not to throttle service requests is predicted revenue. It should be apparent that any metric, e.g., a metric associated with a desired outcome can be used.

Additionally, while embodiments of the present disclosure are discussed in connection with a supply-side platform (SSP) and managing requests for content (e.g., advertising content), it should be apparent that the disclosed systems and methods can be used with any online service, including an online service where requests entail operation costs and an identified metric can be predicted regarding these requests.

According to some embodiments, the disclosed systems and methods first generate a training dataset using unthrottled service request traffic representing past negative and positive outcomes. By way of a non-limiting example, an instance included in the training dataset can comprise feature data corresponding to a service request and data reflective of an outcome of the service request—e.g., whether the service request resulted in a certain outcome. In accordance with one or more embodiments, the training dataset can be used to train an ML model, or success prediction model, to generate a probability of success given input comprising a set of features corresponding to a service request. In accordance with one or more embodiments, the trained model can be updated using feedback including another (e.g., new) corpus of service request traffic.

The disclosed systems and methods then analyze a received service request using the trained outcome prediction model. A feature vector can be generated for the received service request and the generated feature vector can be used as input to the trained outcome prediction model. The outcome prediction model can use the input to generate a win probability given the input.

The disclosed systems and methods can then make a throttling determination using the service request's win probability and a threshold probability. The throttling determination can be based on whether or not the service request's win probability satisfies the threshold probability. The throttling determination made in connection with a service request can be used to manage the service request. In accordance with one or more embodiments, a service request with a win probability satisfying the threshold probability can cause the service provider to not throttle (e.g., the service provider's system generates a response to the service request). Alternatively, a service request with a generated probability failing the threshold probability can cause a service provider to throttle the service request, such that the service provider's system does not process the service request or it queues the service request for later processing.

In accordance with one or more embodiments, the threshold probability used in making the throttling determination can be dynamically determined, or adjusted, using historical data comprising the win probabilities determined for previously-processed service requests. By way of a non-limiting example, the historical win probability data can be used to determine a probability distribution that can then be used to incrementally train, or adjust, the probability threshold using the probability threshold and a predetermined percentile corresponding to a predefined percentage of service requests to be throttled. The input distribution can vary over time. An initial (e.g., predetermined) value can be used as a current value for the threshold probability. The probability threshold can adjust over time in accordance with temporal changes in the input distribution. In accordance with one or more embodiments, the input distribution can be determined using the probabilities determined for incoming service requests in a current time frame. The value of the threshold probability can be determined using a given (e.g., current) input distribution and the predetermined percentile that corresponds to a desired (e.g., predefined) percentage of the service requests being processed and not throttled (or, alternatively, throttled and not processed).

In accordance with one or more embodiments, an online percentage estimator (OPE) can be used to determine the input distribution and percentile values which can be used to determine, or adjust, the probability threshold.

The disclosed systems and methods can be implemented for any type of service request, including, but not limited to, content, recommendation, search, ecommerce and/or any other type of service request. While the discussion herein will focus on SSP service requests for content (e.g., advertising content), it should not be construed as limiting, as any type of service request, whether known or to be known, can be accommodated without departing from the scope of the instant disclosure.

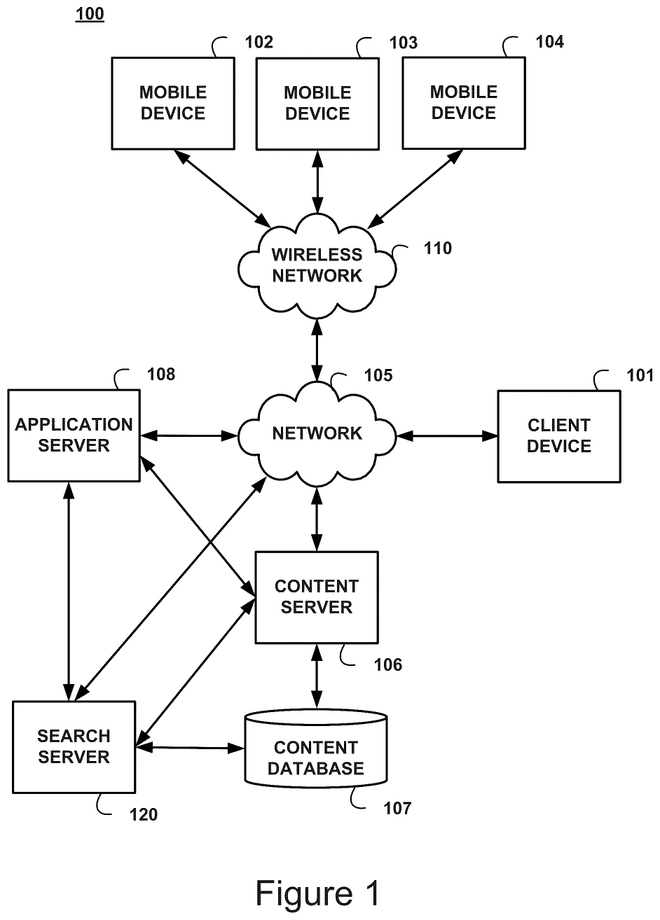

Certain embodiments will now be described in greater detail with reference to the figures. The following describes components of a general architecture used within the disclosed system and methods, the operation of which with respect to the disclosed system and methods being described herein. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as, by way of non-limiting examples, content server 106, application (or “App”) server 108, search server 120 and advertising (“ad”) server (not shown).

One embodiment of mobile devices 102-104 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, smart watch, tablet computers, phablets, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and an HD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, searching for, viewing and/or sharing photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Devices 101-104 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, QUIC (Quick UDP Internet Connection), DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example, A signal packet communicated via the Internet may, for example, be routed via a path of gateways, servers, etc. that may route the signal packet in accordance with a target address and availability of a network path to the target address.

According to some embodiments, the present disclosure may also be utilized within or accessible to an electronic social networking site. A social network refers generally to an electronic network of individuals, such as acquaintances, friends, family, colleagues, or co-workers, which are coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communicate with other members of a social network via a variety of devices. Multi-modal communication technologies refers to a set of technologies that permit interoperable communication across multiple devices or platforms, such as cell phones, smart phones, tablet computing devices, phablets, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as streaming media site/service (e.g., YouTube®), an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers, desktop computers, multiprocessor systems, microprocessor-based or programmable consumer electronics, network PCs, servers, and the like.

Content server 106 can further provide a variety of services that include, but are not limited to, streaming and/or downloading media services, search services, email services, photo services, web services, social networking services, news services, third-party services, audio services, video services, instant messaging (IM) services, SMS services, MMS services, FTP services, voice over IP (VOIP) services, or the like. Such services, for example a video application and/or video platform, can be provided via the application server 108, whereby a user is able to utilize such service upon the user being authenticated, verified or identified by the service. Examples of content may include images, text, audio, video, or the like, which may be processed in the form of physical signals, such as electrical signals, for example, or may be stored in memory, as physical states, for example.

An ad server comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with users. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is advertisers will pay higher advertising rates when they believe their ads are being placed in or along with highly relevant content that is being presented to users. Reductions in the time needed to quantify a high quality ad placement offers ad platforms competitive advantages. Thus higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, etc.) for predicting user behavior. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a website or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 120 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In some embodiments, users are able to access services provided by servers 106, 108 and/or 120. This may include in a non-limiting example, authentication servers, search servers, email servers, social networking services servers, SMS servers, IM servers, MMS servers, exchange servers, photo-sharing services servers, and travel services servers, via the network 105 using their various devices 101-104. In some embodiments, applications, such as a streaming video application (e.g., YouTube®, Netflix®, Hulu®, iTunes®, Amazon Prime®, HBO Go®, and the like), blog, photo storage/sharing application or social networking application (e.g., Flickr®, Tumblr®, and the like), can be hosted by the application server 108 (or content server 106, search server 120 and the like). Thus, the application server 108 can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120, or an ad server or ad network.

Moreover, although FIG. 1 illustrates servers 106, 108 and 120 as single computing devices, respectively, the disclosure is not so limited. For example, one or more functions of servers 106, 108 and/or 120 may be distributed across one or more distinct computing devices. Moreover, in one embodiment, servers 106, 108 and/or 120 may be integrated into a single computing device, without departing from the scope of the present disclosure.

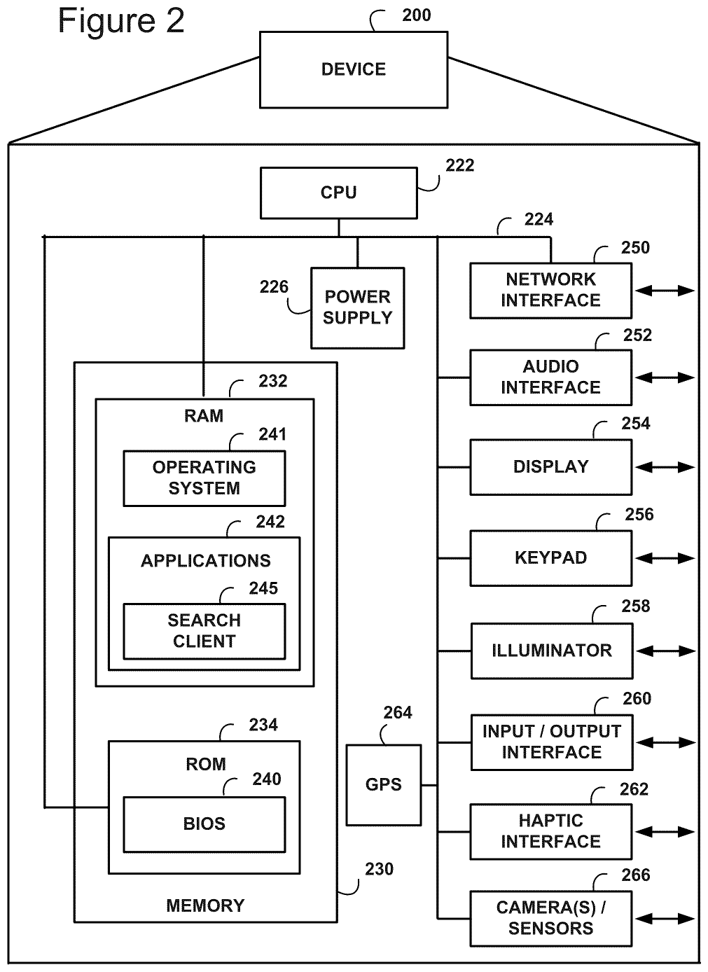

FIG. 2 is a schematic diagram illustrating a client device showing an example embodiment of a client device that may be used within the present disclosure. Device 200 may include many more or less components than those shown in FIG. 2. However, the components shown are sufficient to disclose an illustrative embodiment for implementing the present disclosure. Device 200 may represent, for example, client device 101 and mobile devices 102-104 discussed above in relation to FIG. 1.

As shown in the figure, device 200 includes a processing unit (CPU) 222 in communication with a mass memory 230 via a bus 224. Device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. The positioning of the camera(s)/sensor(s) 266 on device 200 can change per device 200 model, per device 200 capabilities, and the like, or some combination thereof.

Device 200 may optionally communicate with a base station (not shown), or directly with another computing device. Network interface 250 includes circuitry for coupling device 200 to one or more networks, and is constructed for use with one or more communication protocols and technologies as discussed above.

Optional GPS transceiver 264 can determine the physical coordinates of device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of device 200 on the surface of the Earth. In an embodiment, device 200 may, through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of device 200. The mass memory also stores an operating system 241 for controlling the operation of device 200. It will be appreciated that this component may include a general purpose operating system such as a version of UNIX, or LINUX™, or a specialized client communication operating system such as Windows Client™M, or the Symbian® operating system. The operating system may include, or interface with a Java virtual machine module that enables control of hardware components and/or operating system operations via Java application programs.

Memory 230 further includes one or more data stores, which can be utilized by device 200 to store, among other things, applications 242 and/or other data. For example, data stores may be employed to store information that describes various capabilities of device 200. The information may then be provided to another device based on any of a variety of events, including being sent as part of a header during a communication, sent upon request, or the like. At least a portion of the capability information may also be stored on a disk drive or other storage medium (not shown) within device 200.

Applications 242 may include computer executable instructions which, when executed by device 200, transmit, receive, and/or otherwise process audio, video, images, and enable telecommunication with a server and/or another user of another client device. Other examples of application programs or “apps” in some embodiments include browsers, calendars, contact managers, task managers, transcoders, photo management, database programs, word processing programs, security applications, spreadsheet programs, games, search programs, and so forth. Applications 242 may further include search client 245 that is configured to send, to receive, and/or to otherwise process a search query and/or search result using any known or to be known communication protocols. Although a single search client 245 is illustrated it should be clear that multiple search clients may be employed. For example, one search client may be configured to enter a search query message, where another search client manages search results, and yet another search client is configured to manage serving advertisements, IMs, emails, and other types of known messages, or the like.

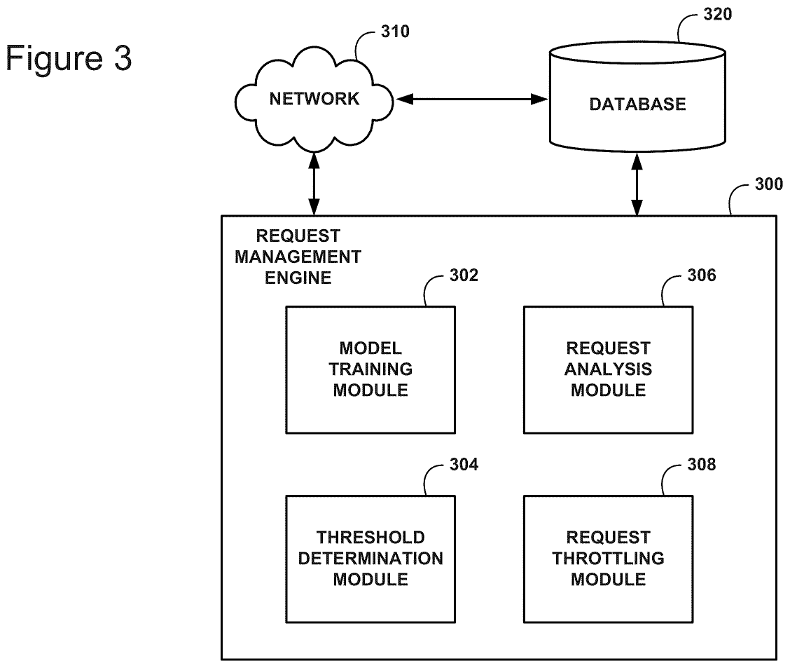

FIG. 3 is a block diagram illustrating the components for performing the systems and methods discussed herein. FIG. 3 includes a request management engine 300, network 310 and database 320. Engine 300 can be a special purpose machine or processor and could be hosted by a stand-alone computing device or a computing device of a service provider, such as and without limitation an application server, content server, social networking server, web server, search server, content provider, email service provider, ad server, and the like, or any combination thereof.

According to some embodiments, engine 300 can be embodied as a stand-alone application that operates in conjunction with an application that receives and processes service requests. Engine 300 can be used to cause the application to throttle a service request. In some embodiments, engine 300 can be incorporated into the application. In some embodiments, some portion, or portions, of engine 300 can be embodied as a standalone application while another portions, or portions can be embodied in the service request application.

The database 320 can be any type of database or memory, and can be associated with a server on a network (such as and without limitation a content server, search server, application server, etc.,). Database 320 comprises a dataset of data and metadata associated with local and/or network information related to users, services, applications, service requests, probability distributions, probability thresholds and the like. Such information can be stored and indexed in the database 320 independently and/or as a linked or associated dataset. It should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user attributes, user preferences or settings, user demographic information (e.g., gender, age, etc.), user location information, user biographic information, user device information (e.g., operating system), geographic location information (e.g., device, user, etc.) and the like, or some combination thereof. A user can be any entity making a service request. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with a service request. According to some embodiments, such service request information can be represented as an n-dimensional vector (or feature vector) for each service request, where each node in the n-dimensional vector represents a feature of the service request.

While the discussion below will involve vector analysis in connection with a service request for content (e.g., ad content), embodiments of the present disclosure can be used in connection with any type of service request.

The network 310 can be any type of network such as, but not limited to, a wireless network, a local area network (LAN), wide area network (WAN), the Internet, or a combination thereof. The network 310 facilitates connectivity of engine 300, and the database of stored resources 320. Indeed, as illustrated in FIG. 3, engine 300 and database 320 can be directly connected by any known or to be known method of connecting and/or enabling communication between such devices and resources.

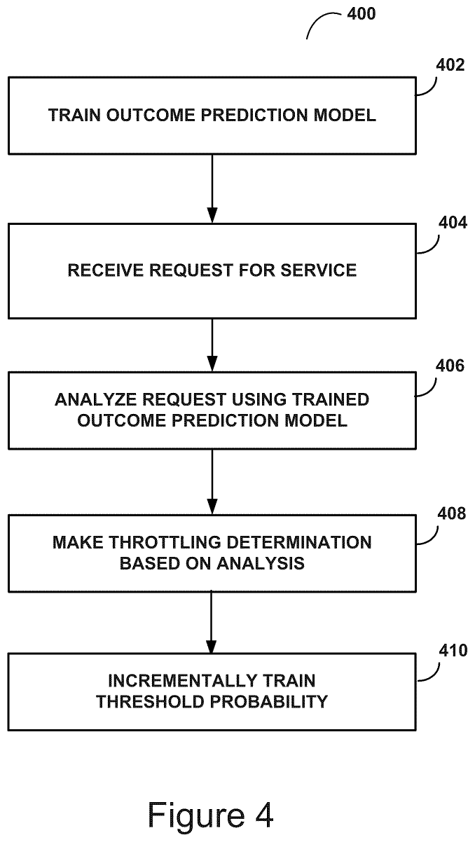

The principal processor, server, or combination of devices that comprises hardware programmed in accordance with the special purpose functions herein is referred to for convenience as engine 300, and includes model training module 302, threshold determination module 304, request analysis module 306, and request throttling module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed with reference to FIG. 4.

As discussed in more detail below, the information processed by the engine 300 can be supplied to the database 320 in order to ensure that the information housed in the database 320 is up-to-date as the disclosed systems and methods leverage real-time information associated with the service requests being processed by engine 300, as discussed in more detail below.

FIG. 4 provides a process flow overview in accordance with one or more embodiments of the present disclosure. Process 400 of FIG. 4 details steps performed in accordance with exemplary embodiments of the present disclosure for intelligent service request management. According to some embodiments, as discussed herein with relation to FIG. 4, the process involves automatically training an outcome prediction model to generate a win probability given input representative of a service request, analyze a service request using the trained outcome prediction model and make a throttling determination for the service request based on the analysis, where the throttling determination can be used to cause a service provider to throttle a service request.

At step 402, which can be performed by module 302 of engine 300, a machine learning (ML) model, also referred to as an outcome prediction model, can be trained to determine an outcome prediction, or win probability (or probability of success), indicating a likelihood, or probability, that a service request made to a service provider results in a certain (e.g., predefined) outcome, or event. By way of a non-limiting example, the outcome can be one identified by the service provider. The outcome can be one that is beneficial for the service provider, such as and without limitation positive user engagement, content publication, etc. As discussed, the outcome prediction model used in connection with disclosed embodiments can be trained to make a prediction in connection with any metric. By way of one non-limiting example, the metric can be revenue and the outcome prediction model can be trained to provide a revenue prediction—e.g., predicted revenue.

In accordance with one or more embodiments, a corpus of training data comprising unthrottled service request traffic representing past negative and positive service request outcomes can be used to generate a training dataset. By way of a non-limiting example, an instance included in the training dataset can comprise feature data corresponding to a service request and labeling data reflective of an outcome of the service request—e.g., whether or not the service request resulted in a certain outcome, which can be a predefined outcome.

In accordance with one or more embodiments, the training dataset can be used to train an ML model, or outcome prediction model, to generate a win probability for a service request given input comprising a set of features representative of the service request. In accordance with one or more embodiments, the trained model can be updated using feedback including an additional (e.g., new) corpus of service request traffic.

By way of a non-limiting example, the trained ML model can be a feature enhanced collaborative-filtering (CF)-based model, such as and without limitation a One-Pass Factorization of Feature Sets (OFFSET) ML model. According to OFFSET, a win probability can be represented as follows:

$${pET}_{u , a} = σ ( {s}_{u , a} ) ∈ [ 0 , 1 ] , \qquad Expr . ( 1 )$$

where pET_{u,a}, or predicted event probability, denotes a win probability, σ(x)=(1+e^{-x})⁻¹, is the Logistic sigmoid function, and

$${s}_{u , a} = b + {v}_{u}^{T} {v}_{a} , \qquad Expr . ( 2 )$$

where vᵤ, vₐ∈ [symbol] ^{D} denote latent factor (LF) vectors representing, respectively, a service requester and a candidate for response to the service request, and b denotes the model bias. By way of a non-limiting example, in the case of a service request requesting content (e.g., ad content) for display at a user device, the service requester LF vector can reflect features of the user and the candidate response can reflect features of a given content item that is being considered as a response to the service request. By way of a further non-limiting example, the product vᵤ^{T}vₐ indicates a tendency of the service requester (e.g., a content publisher, website provider, end user, etc.) towards the candidate response (e.g., ad content), where a higher score translates into a higher pET, or win probability.

It should be apparent that OFFSET is one example of a machine learning algorithm that can be used to train a prediction model used in connection with embodiments of the present disclosure, it should be apparent that any machine learning algorithm now known or later developed can be used.

In accordance with one or more embodiments, OFFSET can learn the model parameters by minimizing a logistic loss of the training data (e.g., a set of past negative and positive events) using a one-pass online gradient descent (OGD), which can be represented as:

$$\begin{matrix}arg im \\ Θ\end{matrix} {\sum }_{( u , a , y ) ∈ T} ℒ ( u , a , y ) , \qquad Expr . ( 3 )$$

where [symbol] (u, a, y) can be represented as

$$- ( 1 - y ) log {pET}_{u , a} - y log ( {pET}_{u , a} ) + \frac{λ}{2} {‖ Θ ‖}_{2}^{2} , \qquad Expr . ( 4 )$$

where y∈{0,1} is an indicator (or label) for the event (e.g., a past negative or positive event) involving the service requester and candidate response, and λ denotes the L2 regularization parameter. The OGD step sizes can be determined by a variant of the adaptive gradient (AdaGrad) algorithm.

The OFFSET machine learning algorithm can be used to apply an incremental training approach, where it continuously updates its model parameters with each batch of new training events (e.g., every 15 minutes, 4 hours, etc.) The OFFSET algorithm also uses an adaptive online hyper-parameter tuning mechanism that utilizes the parallel map-reduce architecture (e.g., of the Gemini native backend platform), and attempts to tune OFFSET hyper-parameters (e.g., OGD initial step size and AdaGrad parameters) to match the varying conditions (e.g., marketplace conditions, such as and without limitation trend, temporal effects, etc.).

At step 404, a service request can be received by engine 300. The received service request can be a request for service directed to a service provider. At step 406, which can be performed by request analysis module 306, the received service request can be analyzed using the outcome prediction model trained at step 402 and a feature vector. The feature vector can be generated for the received service request using data corresponding to the service request (e.g., data about the entity making the service request) and a candidate response (e.g., data about a possible, or candidate, response to the request). The generated feature vector can be used as input to the trained outcome prediction model. The outcome prediction model can use the input to generate a win probability given the input.

At step 408, which can be performed by request throttling module 308, a throttling determination can be made based on the analysis performed at step 406. The disclosed systems and methods can make the throttling determination using the service request's win probability and a threshold probability. The throttling determination can be based on whether or not the service request's win probability satisfies the threshold probability. In accordance with one or more embodiments, a service request with a win probability satisfying the threshold probability is not throttled (e.g., the throttling determination can cause the service provider's system to generate a response to the service request and not throttle the request). Alternatively, a service request with a generated probability failing the threshold probability is throttled (e.g., the throttling determination can cause the service provider's system to forego processing the service request or cause the service provider to queue, or deprioritize, the service request for later processing).

In accordance with one or more embodiments, the threshold probability used to make the throttling determination, at step 408, can be set to an initial value. At step 410, which can be performed by threshold determination module 304 of FIG. 3, the threshold probability can be incrementally trained using historical information in the form of historical data comprising the win probabilities determined in connection with service requests previously processed by engine 300. Various mechanisms can be used to incrementally train the threshold probability value using historical data. By way of a non-limiting example, online percentage estimation (OPE) can be used with historical win probabilities determined for previous service requests to determine a statistical distribution which can be used to dynamically determine the threshold probability.

OPE can refer to a number of algorithms that operate in streaming and incremental modes and estimate a threshold probability that corresponds to a predefined percentile of input data (e.g., service requests). In accordance with one or more embodiments, OPE can be used to monitor the win probabilities that are determined by module 306 of engine 300, estimate a statistical distribution of the win probabilities and determine an estimated threshold probability that corresponds to a certain (e.g., predefined) percentile. By way of a non-limiting example, OPE can be used to estimate the threshold probability value for throttling service requests so that only a predefined percentage (e.g., 30%) of the service requests are throttled (e.g., not processed by a service provider).

Quantile Regression (QR) and t-Digest are examples of OPE approaches that can be used in connection with embodiments of the present disclosure. It should be apparent that other OPE approaches now known or later developed can be used.

The QR approach can be used to return a value, z, such that t portion of entries, {yᵢ}, have a score≤z, where z refers to the threshold probability that can be adjusted by the algorithm, τ is the targeted percentile and yᵢ is the current win probability. The algorithm used with the QR approach can be generated by minimizing a total loss function. The total loss function can be expressed as:

$$L = {\sum }_{{y}_{i}} {ℒ}_{τ} ( z , {y}_{i} ) , \qquad Expr . ( 5 )$$

where the loss function can be expressed as

$${L}_{τ} ( z , y ) = \{ \begin{matrix}( z - y ) \cdot ( 1 - τ ) , & z - y \geq 0 \\ ( z - y ) \cdot ( - τ ) , & z - y < 0\end{matrix} \qquad Expr . ( 6 )$$

and the total loss derivative can be expressed as

$$Expr . ( 7 )$$

$$\frac{dL}{dz} = \frac{d}{dz} ( {\sum }_{z \geq {y}_{i}} ( z - {y}_{i} ) \cdot ( 1 - τ ) + {\sum }_{z < {y}_{i}} ( {y}_{i} - z ) \cdot ( τ ) ) = {\sum }_{z \geq {y}_{i}} ( 1 - τ ) + {\sum }_{z < {y}_{i}} τ$$

The total loss derivative can be set to zero,

$$\frac{dL}{dz} = 0 ,$$

to determine z that provides the τ^{th} percentile (e.g., determine a threshold probability adjusted to throttle only a predefined percentage of service requests). A gradient descent-like algorithm can be used to determine an optimal z value. An updated expression can be represented as:

$$z ← \{ \begin{matrix}( z - η ) \cdot ( 1 - τ ) , & z - y \geq 0 \\ ( z + η ) \cdot ( τ ) , & z - y < 0\end{matrix} ; \qquad Expr . ( 8 )$$

$$η ← \{ \begin{matrix}\frac{η}{2} , & \vert z - y \vert < η \\ η , & otherwise\end{matrix}$$

In accordance with one or more embodiments, Expression (8) can be used (e.g., at step 408 of FIG. 4) to incrementally train the threshold probability. In accordance with one or more embodiments, the threshold probability can be incrementally trained using historical information in the form of win probabilities determined in connection with service requests processed by engine 300.

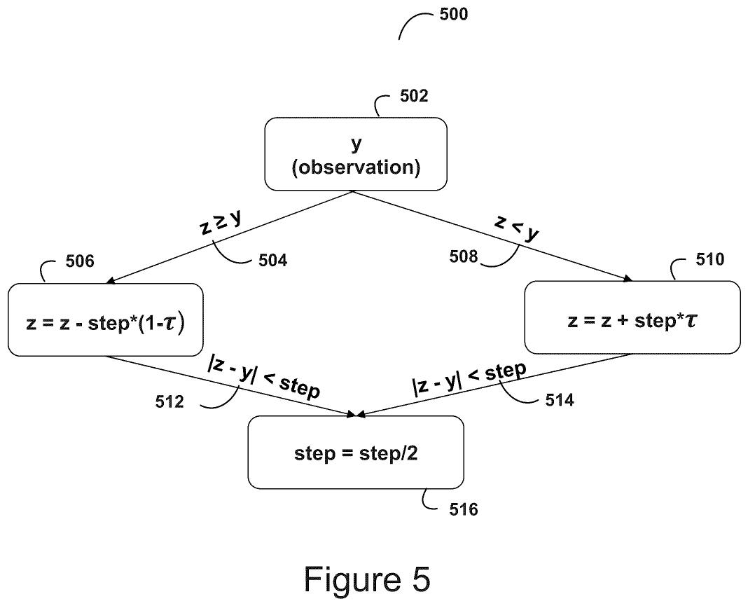

FIG. 5 is a schematic diagram illustrating application of Expression (8) determined using QR to incrementally train a threshold probability in accordance with some embodiments of the present disclosure. In example 500 shown in FIG. 5, a win probability determined using the outcome prediction model (which is referred to as y (observation) in example 500) is analyzed 502 in connection with the current threshold probability to determine which of branches 504 and 508 to take, where each branch results in an adjustment determination is connection with the current threshold probability.

Branch 504 corresponds to a determination that the win prediction fails to satisfy the current threshold probability (e.g., where z≥y indicating that the win probability is less than or equal to the current threshold probability in the example). Branch 504 results in a branching to adjustment 506, where the current threshold probability can be downwardly adjusted, or decreased, based on the current step value (e.g., η in Expression (8)) and τ, which represents the predefined percentile (as in Expression (8)).

Branch 508 corresponds to a determination that the win probability satisfies the threshold probability (e.g., where z<y indicating that the win probability is greater than the current threshold probability in the example). Branch 508 results in a branching to adjustment 510, where the current threshold probability can be upwardly adjusted, or increased, based on the current step value and the predefined percentile.

As shown by branches 512 and 514, after adjustment 506 or 510, a determination is made whether to adjust the current step value at adjustment 516. In example 500, the adjustment 516 is made where it is determined that |z−y|<step. In accordance with one or more embodiments, the processing shown in example 500 can be made in connection with each current win probability determined by the trained model.

A significant advantage of the QR approach is its constant space complexity. It stores values for two variables: step size, η, and the temporal value of the threshold probability, z. Additionally, the time complexity associated with the QR approach is linear in the number of service requests.

As discussed, t-Digest provides another non-limiting example of an OPE approach that can be used to incrementally train the threshold probability using historical information in the form of historical data comprising the win probabilities determined in connection with service requests previously processed by engine 300. In accordance with this approach, a t-Digest (also referred to as a sketch, or probabilistic, data structure) can be used to maintain clusters of samples (e.g., win probabilities) along with, for each cluster, the number of samples assigned to the cluster and a mean determined using samples (e.g., the win probabilities) assigned to the cluster.

The clustering can then be used to estimate quantile-related statistics with particularly high accuracy near the tails of a distribution. By way of a non-limiting example, buffers can be used to store the incoming samples, and data stored in a buffer can be sorted and merged with the centroids computed from previous samples when the buffer reaches a certain point (e.g., a filled state). This approach represents a trade-off between the size of the digest and the accuracy of the estimates, presents considerations of memory bounds and relative accuracy and can operate in a strictly online fashion.

In accordance with one or more embodiments, a t-Digest can be used to maintain an estimate of a cumulative distribution function (CDF) of a set of data (e.g., win probabilities). The CDF can be used to determine a threshold probability at a given percentile. By way of a non-limiting example, assume that the given percentile is predefined such that a certain percentage (30%) of service requests are throttled. The CDF of win probabilities encountered up to a certain point can be used to determine a win probability to use as a threshold probability so that only the predefined percentage of service requests are throttled.

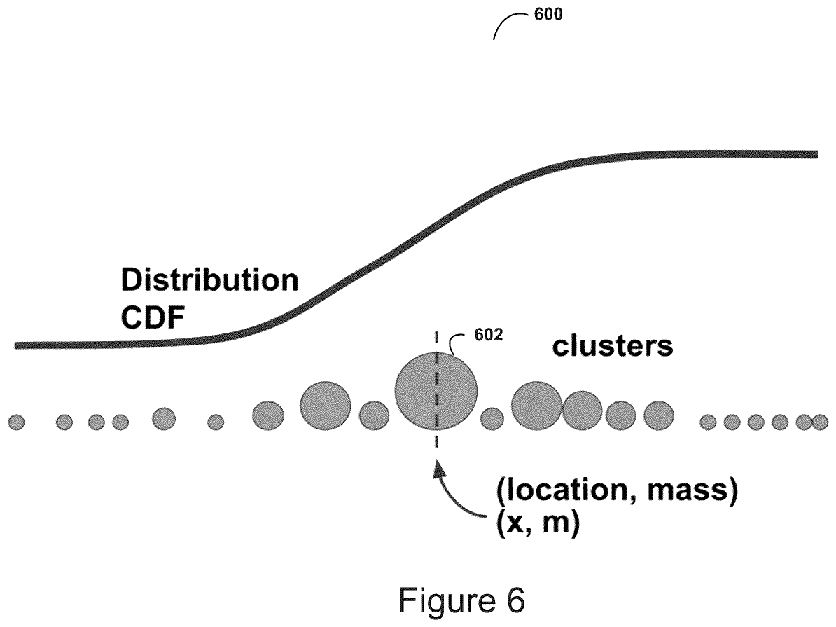

FIG. 6 provides an exemplary illustration of a CDF of win probabilities that can be maintained using a t-Digest in accordance with one or more embodiments of the present disclosure. In example 600, each circle represents a cluster of assigned win probabilities. Using cluster 602 as an example, each cluster has a location, x, and mass, m. The location, x, represents the centroid of cluster 602 determined using the win probabilities assigned to (or belong to) cluster 602. By way of a non-limiting example, the centroid can be determined to be the mean of the win probabilities assigned to cluster 602. The mass, m, represents the number of win probabilities assigned to cluster 602.

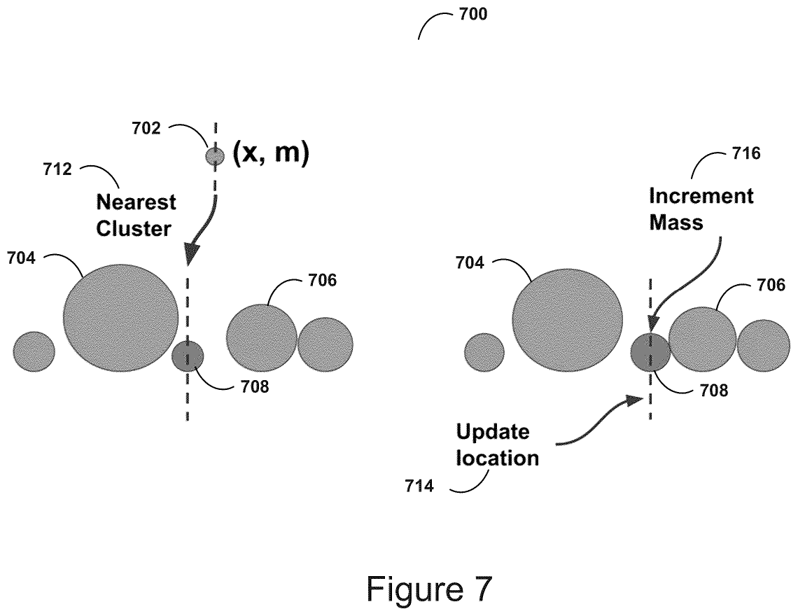

FIG. 7 provides an illustration of adding a win probability to a cluster in a CDF in connection with the t-Digest approach in accordance with one or more embodiments of the present disclosure. In example 700 of FIG. 7, instance 702 represents a win probability (e.g., a win probability determined by the trained model in connection with a service request and possible response) that is to be added to a cluster. Instance 702 has a location, x, that corresponds to the win probability and a mass, m, that is equal to 1. Instance 702 can be added to an existing cluster (e.g., cluster 704 or cluster 706) based on a nearest cluster determination 712.

Determination 712 can be made based on the location(s), x, (e.g., centroid(s)) associated with the cluster(s) closest to the location, x, of instance 702. If the distance between the locations of instance 702 and the nearest cluster(s) exceeds a threshold distance, instance 702 can be used to create a new cluster. Determination 712 can also take into account the size of the nearest cluster(s), where a new cluster can be generated if the size of the nearest cluster(s) exceeds a certain (e.g., predefined) size threshold. In example 700, instance 702 is used to create a new cluster 708 based on determination 712.

After instance 702 is assigned to a new or existing cluster based on determination 712, determination 714 determines a location, x, for the cluster (e.g., cluster 708 in example 700) and determination 716 determines a mass, m, for the cluster. In example 700, the location, x, is the win probability value and the mass, m, is set to one since a new cluster was created for instance 702. Where instance 702 is added to an existing cluster (e.g., cluster 704), the location, x, of instance 702 is used to update the location, x, determined for the cluster and the mass, m, of the cluster is incremented by one to represent the addition of instance 702.

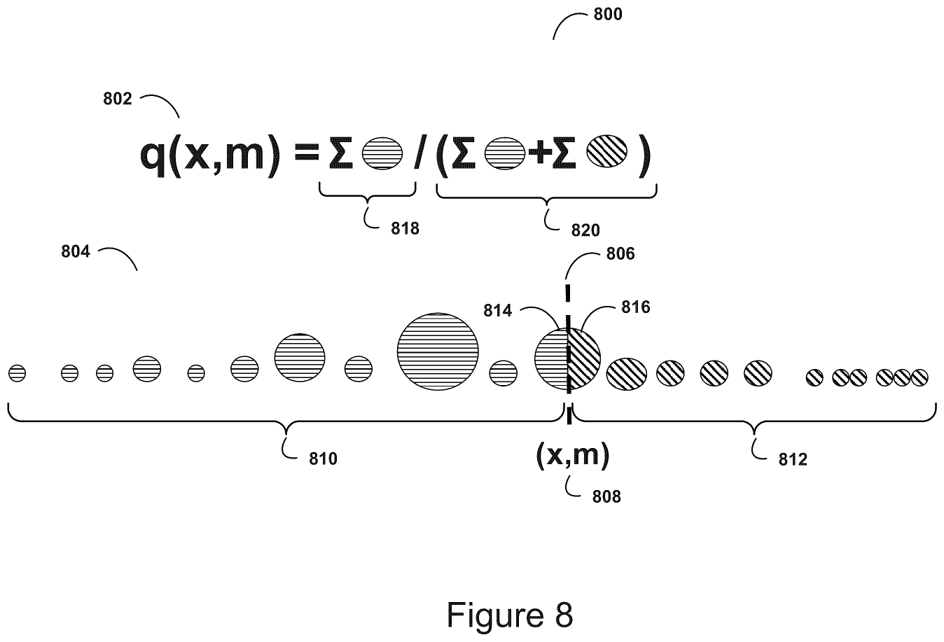

FIG. 8 provides an example illustrating a quantile determination using a t-Digest in accordance with one or more embodiments of the present disclosure. Example 800 of FIG. 8 includes a t-Digest 804 representing a CDF determined using a set of historical win probabilities determined in accordance with the present disclosure. As can be seen, t-Digest 804 comprises a number of clusters. As discussed in connection with FIG. 7, each cluster has a location, x, and a mass, m.

Expression 802 can be used to determine a given quantile, or percentile, corresponding to a given location, x, in t-Digest 804. According to exemplary expression 802, the quantile, q(x, m) can be determined using a first sum 818 and a second sum 820. Sum 818 is a sum of the mass corresponding to clusters 810 to the left of location 806 (including the mass associated with the cluster portion 814 to the left of location 806). Location 806 can be associated with a cluster that has a location and mass 808. Sum 820 is an aggregate of the mass associated with all of the clusters—i.e., sum 818 together with a sum of the mass associated with clusters 812, which includes the mass associated with portion 816 to the right of location 806. According to exemplary expression 802, the quantile, q(x, m) can be determined by dividing sum 818 by sum 820.

Assuming for the sake of example, that the mass is the same to the left and right of location 806 in t-Digest 804, the quantile, q(x, m) determined using expression 802 would be 50%, or 50% of the win probability occurrences fall to the left of location 806 and 50% of the win probability occurrences fall to the right of location 806. A threshold probability equal to location, x, can be used so that 50% of the service requests are throttled. Generally speaking, expression 802 can be used with t-Digest 804 to identify a threshold probability associated with any quantile, where the quantile can correspond to a predefined percentage (e.g., 30%) that can result in a corresponding level of throttling (e.g., 30% of the service requests are throttled).

Embodiments of the present disclosure are not limited to either the t-Digest or the QR OPE approaches or OPE. It should be apparent that other approaches can be used to use historical win probability data to dynamically adjust a probability threshold to achieve a certain (e.g., predefined) amount of throttling—e.g., limiting the number of service requests throttled in accordance with a predefined percentage.

Process 400 will now be described in connection with a use case involving requests for content (e.g., advertising, or ad, content) to be served by online publication, where such service requests can be intelligently managed using engine 300. Additionally, in this non-limiting example, the outcome, or event, for which a win probability is determined by a trained outcome prediction model can be defined to be a publication of the content in a web page presented to an end user (e.g., in a browser user interface displayed by a computing device of the user). By way of a non-limiting example, the content can be ad content, in which cans such a publication can be referred to as ad impression.

It should be apparent that other outcomes other than content publication can be used in this exemplary scenario, including without limitation user engagement with the content (e.g., selection of the content by the user). It should be apparent that the disclosed systems and methods can be used with any type of service provider and outcome.

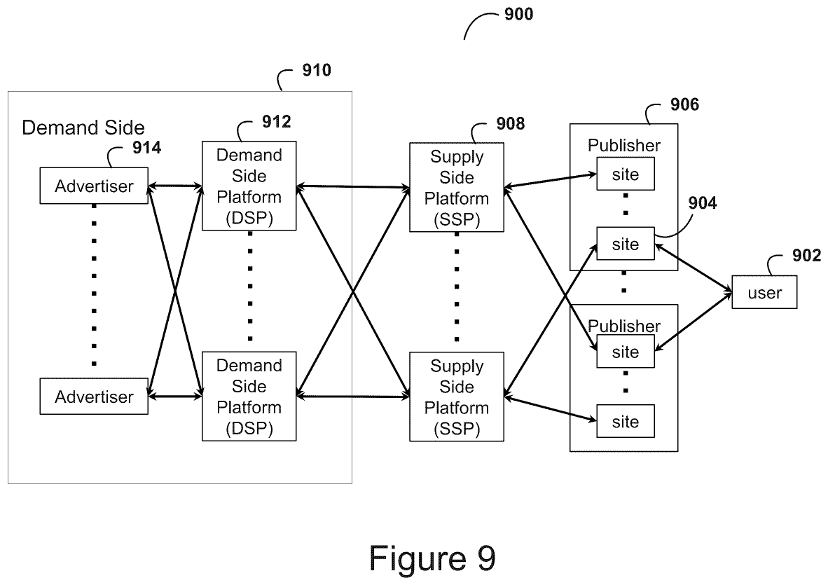

FIG. 9, which is described below, provides an exemplary example of a technology platform involving content service requests intelligently managed in accordance with embodiments of the present disclosure. In example 900 shown in FIG. 9, publisher 906, SSP 908, DSP 912 and advertiser 914 can each be service providers and can make use of the disclosed systems and methods to intelligently manage service requests.

In example 900, publisher 906 has a number of websites 904 that can receive and respond to service requests (e.g., web page requests, content recommendation requests, social networking requests, ecommerce requests, etc.) of its users (e.g., user 902). In example 900, publisher 906 can also be a service requester (e.g., a requester on behalf of user 902) making content requests that it communicates to SSP 908. Publisher 906 can request content (e.g., advertising content) to include in a web page that is served by site 904 for display by a computing device of user 902.

In example 900, SSP 908 can be part of a real-time bidding (RTB) process that can be used in online advertising. Site 904 can comprise an amount of space in each of its web pages that can be used to display advertising content. Space on a web page used to display advertising content can be referred to as ad space. Publisher 906 can request ad content from advertiser 914, via SSP 908 and demand side 910, to accommodate its ad space inventory included in web pages displayed to its users (e.g., user 902).

By way of a non-limiting example, SSP 908 can receive billions of service requests for advertising content daily from hundreds of publishers 906 to populate their advertising space inventory. In example 900, demand side 910 includes a number of service providers labeled demand-side platform 912 and advertiser 914. SSP 908 can receive a service request from publisher 906 requesting content and comprising information that can be used by the demand side 910 to respond with ad content. SSP 908 can conduct an auction for each ad request before sending a number of ad content items to publisher 906. Publisher 906 can select a content item (e.g., an advertising content item) from the ad content items received from a number of SSPs 908.

As discussed, an SSP 908 can receive billions of service requests daily from publishers 906. Only a tiny fraction of the service requests received by SSP 908 ultimately result in an impression where an ad content item returned in response to a service request is included in ad space of a web page displayed to user 502. For example, less than 1% of the billions of service requests received by SSP 908 might result in an actual impression. As illustrated by the low percentage, most service requests for ad content do not yield an actual impression. However, each service request incurs operational costs (e.g., $1.20 per every 1 million auctions)—e.g., costs associated with processing a service request, communicating a response, etc. In addition, bidders on the demand side 910 can enforce a queries-per-second (QPS) limitation.

The disclosed system and methods can be used by a service provider such as SSP 908 to intelligently manage the service requests for ad content and cull service requests that won't likely result in an actual impression. To name a few exemplary advantages, QPS limitations can be better realized and operational costs incurred by an SSP 908 can be reduced by intelligently managing service requests.

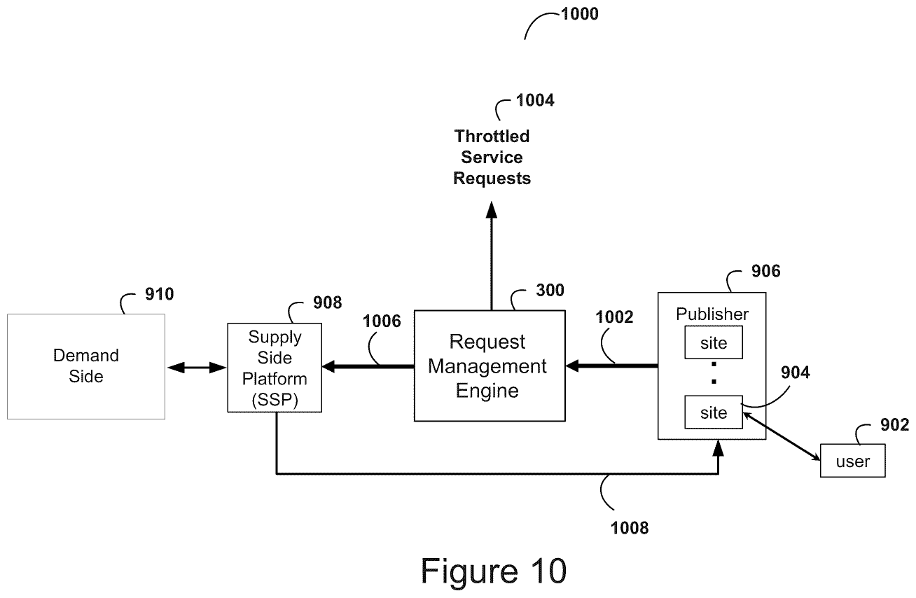

FIG. 10 provides an exemplary example in which request management engine 300 can be used to manage service requests in accordance with one or more embodiments of the present disclosure. In example 1000, request management engine 300 is shown as being a separate component. While request management engine 30 can be a separate, stand-alone component, some or all of request management engine 300 can be a component of a service provider (e.g., SSP 908).

In example 1000, request management engine 300 can be used to manage service requests 1002 (e.g., content requests, such as and without limitation requests for ad content) from publisher 906 directed to SSP 908. While engine 300 is being used in example 1000 to manage service requests directed to SSP 908, engine 300 can be used in connection with any service providers, including without limitation the service providers discussed in connection with this example and example 900.

As discussed in connection with step 402 of FIG. 4, an outcome prediction model can be trained to determine an outcome prediction, or win probability (or probability of success), indicating a likelihood, or probability, that a service request made to a service provider results in a certain outcome, or event. In the example 1000, the service provider can be SSP 908 and the outcome, or event, can be an ad impression, where the win probability indicates a likelihood that the service request results in a content item (e.g., ad content) (illustrated as response 1008) communicated to publisher 906 in response to service request 1002 being displayed in a web page of site 904 at a computing device of user 902.

In example 1000, a corpus of training data used to train outcome prediction model can comprise unthrottled service request data corresponding to responses 1008 that do not result in corresponding content item being included in a website display as past negative outcomes and responses 1008 that result in corresponding content item being included in a website display as positive service request outcomes. By way of a non-limiting example, an instance included in the training dataset can comprise feature data corresponding to a service request and labeling data (e.g., a label) reflective of an outcome of the service request—e.g., whether the service request resulted in a predefined outcome.

In accordance with one or more embodiments, the feature data representing a service request can be determined by combining a first feature vector (also referred to as a user vector) generated using data corresponding to the service request 1002 and a second feature vector (also referred to as a content vector) corresponding to data about the response 1008. By way of a non-limiting example, the user vector can include data about one or more of the user 902, site 904 and publisher 906. The user and content vectors can be constructed using their features to overcome data sparsity issues. In accordance with one or more embodiments, the feature vectors described herein can be learned latent factor (LF) vectors.

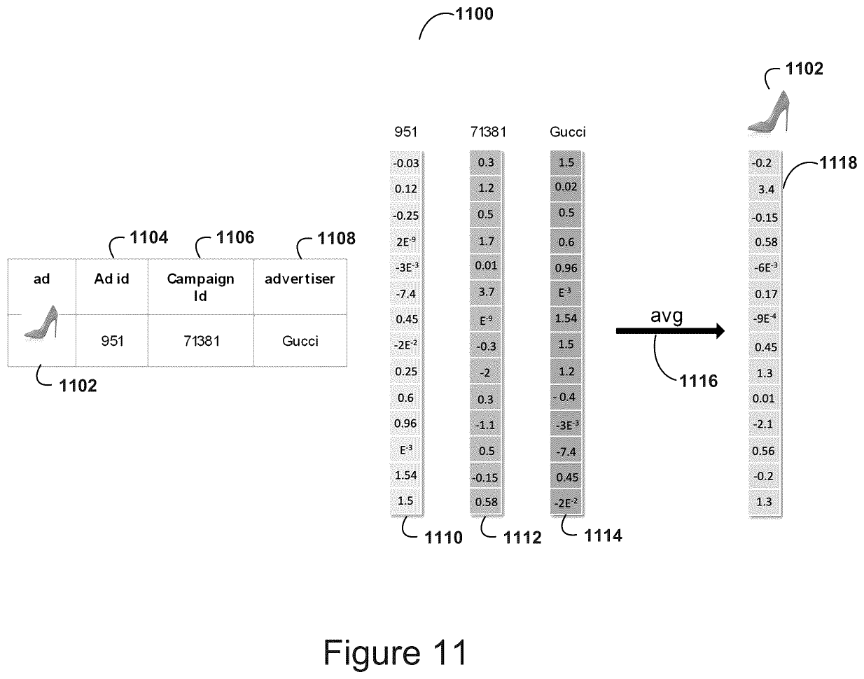

FIG. 11 provides an exemplary example of response vector generation in accordance with one or more embodiments of the present disclosure. In accordance with one or more embodiments, the LF response vector can be used as a representation of response 1008 (e.g., a feature vector representing the response 1008). It should be apparent that any features associated with response 1008 can be used to generate a feature vector for the response. The features can include features of content (e.g., features of a content item) provided with response 1008.

In accordance with one or more embodiments, the response vector corresponding to a response 1008 can be a LF vector generated using a aggregation (e.g., summation, average, etc.) of its features' LF vectors, where each LF feature vector is a D-dimensional vector. In example 1100, the response comprises content depicted as ad content 1102 having corresponding features 1104. 1106 and 1108, which features correspond to information identifying the ad content (e.g., content, or ad, ID), advertising campaign ID and ad category. Of course, it should be apparent that other additional or different features can be used. By way of a non-limiting example, information associated with one or more content items communicated by a service provider can be used to generate the feature vector corresponding to response 1008.

In example 1100, LF vectors 1110, 1112 and 1114 represent features 1104, 1106 and 1108, respectively. In the example 1100, the LF vectors 1110, 1112 and 1114 can be aggregated (e.g., averaged) 1116 to generate the LF response vector 1118.

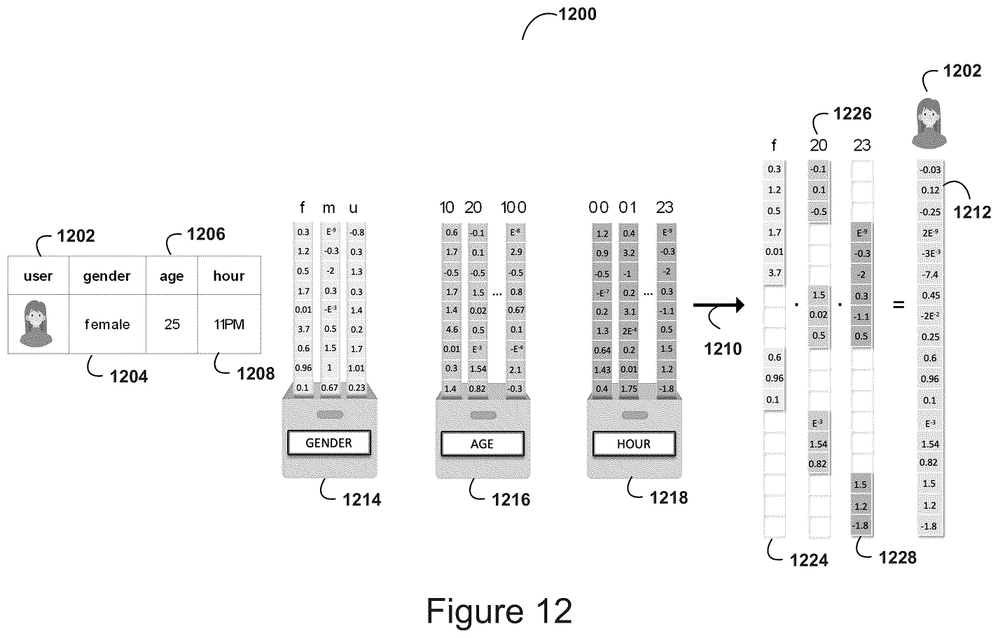

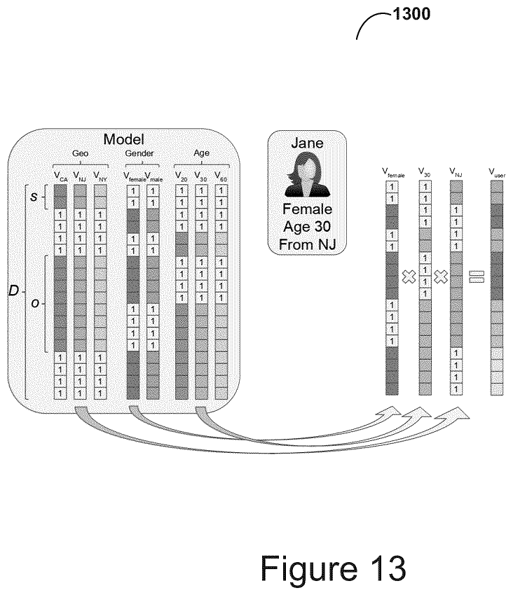

In accordance with one or more embodiments, a feature vector representing a service request or a response can be generated in such a way as to support non-linear dependencies between feature pairs. By way of a non-limiting example, a feature vector representing a service request can comprise K-features corresponding to one or more items of information about user 902 (gender, device information, geolocation information, etc.), site 904 and publisher 906. Support for feature interdependencies is discussed below in connection with FIGS. 12 and 13 and generation of a service request feature vector.

FIG. 12 provides an exemplary example of service request vector generation in accordance with one or more embodiments of the present disclosure. In example 1200 of FIG. 12, feature vector 1212 can be used as a representation of service request 1002. In accordance with one or more embodiments, feature vector 1212 can correspond to service request 1002 and can be a LF feature vector generated using a product of its features' LF vectors 1224, 1226 and 1228, where each LF feature vector can be a D-dimensional vector. In example 1200, the feature vector 1212 can include information about features of a user, such as and without limitation a gender feature 1204, age feature 1206 and a temporal feature 1208 (e.g., indicating the hour of the request) of the request. It should be apparent that other features associated with service request 1002 can be used to generate service request vector 1212.

Each of features 1204, 1206 and 1208 has a set of LF feature vectors—e.g., feature vector sets 1214, 1216 and 1218 corresponding to, respectively, features 1204, 1206 and 1208. Each feature vector in feature vector set 1214 corresponds to a value of feature 1204, each feature vector in feature vector set 1216 corresponds to a value of feature 1206, and each feature vector in feature vector set 1218 corresponds to a value of feature 1208. An LF feature vector is selected (as indicated by reference 1210) from each of feature vector sets 1214, 1216 and 1218 based on the value associated with each feature 1204. 1206 and 1208 for user 1202.

In example 1200, one or more features represented in a gender LF feature vector (in set 1214) can overlap (or have an interdependency) with one or more features represented in an age LF feature vector (in set 1216) and/or with one or more features represented in an hour LF feature vector (in set 1218). There can also be feature interdependencies in connection with features represented in the age LF feature vectors and hour LF feature vectors. Additionally, one or more other features represented in a gender, age, or hour LF feature vector can be independent (or lack any dependency).

In accordance with one or more embodiments, before the LF feature vectors selected from sets 1214, 1216 and 1218 are combined (e.g., using dot products) resulting in LF feature vector 1212, each selected LF feature vector 1224, 1226 and 1228 can be modified to insert padding features (e.g., with a value of one) to accommodate non-overlapping, independent features. In example 1200, the padding features are represented by blank features in LF feature vectors 1224, 1226 and 1228. Each of these padding features can be given the value of one before combining the LF feature vectors to generate service response LF feature vector 1212.

FIG. 13 provides another example of combining LF feature vectors having inter-vector feature dependencies and feature independence in accordance with one or more embodiments of the present disclosure. In example 1300, the dimension, d, of a single LF feature vector that supports inter-vector feature dependencies as well as feature independence can be represented as

$$d = ( K - 1 ) \cdot o + s , \qquad Expr . ( 9 )$$

where K is the number of types of learned vectors (e.g., gender, age, geolocation, etc.), o represents the number of entries allocated to each pair of features and s denotes the number of features devoted to each feature vector alone (e.g., s can represent the number of independent, non-overlapping features). The dimension, D, of a combined feature vector (e.g., service response feature vector 1212 in example 1200 of FIG. 12) can be represented as

$$D = ( \begin{matrix}K \\ 2\end{matrix} ) \cdot o + K \cdot s , \qquad Expr . ( 10 )$$

where K, o, and s can denote values as indicated in connection with Expr. (9) and

$$( \begin{matrix}K \\ 2\end{matrix} )$$

can be read as K choose 2 and can indicate that there are K ways to choose elements. By way of a non-limiting example, assuming that K is equal to three (e.g., [1, 2, 3]),

$$( \begin{matrix}3 \\ 2\end{matrix} )$$

would be equal to 3 (e.g., 12, 13 and 23).

Returning again to FIG. 11, feature vector 1118 representing a response associated with service request 1002 and feature vector 1212 representing service request 1002 can be combined (e.g., using a dot product operation) and used by request management engine 300 to make a throttling determination using process 400. By way of a non-limiting example, response feature vector 1118 can be combined (e.g., using a dot product) with service request vector 1212, and the combined vector can be input to outcome prediction model generated at step 402 of FIG. 4 to obtain a win probability, which can represent the likelihood that the content will be published by publisher via site 904 for display at a computing device of user 902. A determination of the win probability, P_{win}, can be expressed as

$${P}_{win} ( u , a ) = \frac{1}{1 - {exp}^{- ( b + {v}_{u}^{T} {v}_{a} )}} , \qquad Expr . ( 11 )$$

where vᵤ, vₐ denote the service request and response LF vectors, respectively, b denotes the model bias, and the product, vᵤ^{T}vₐ, indicates the tendency of a user, u, (e.g., publisher 906, site 904 and/or user 902) towards the response, a, (e.g., a content item). By way of a non-limiting example, a higher score can be indicative of a higher P_{win}. Expr. (11) can be found using Exprs. (1 and (2), with pET_{u,a} denoting P_{win}, and vice versa.

At step 408 (of FIG. 4), the service request 1002 can be intelligently managed using the analysis of the service request 1002 performed at step 406. With reference to FIG. 10, throttled requests 1004 represent those service requests 1002 having a P_{win} failing to satisfy the threshold probability while service requests 1006 represent those service requests 1002 having a P_{win} satisfying the threshold probability.

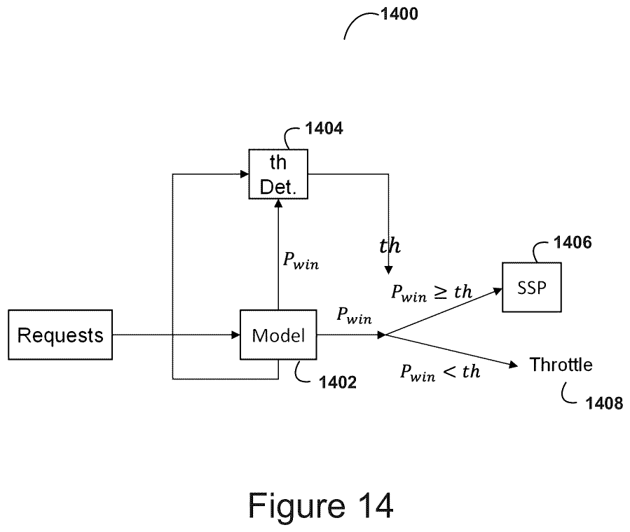

FIG. 14 provides an exemplary example of intelligently managing requests based on a win probability and threshold probability in accordance with one or more embodiments of the present disclosure. In example 1400 of FIG. 14, a LF feature vector representation determined in connection with each service request (e.g., each service request 1002) can be input to model 1402 (e.g., an outcome prediction model trained at step 402 of FIG. 4) and the output of model 1402 (e.g., P_{win}) can be used to make a threshold probability determination 1404 (e.g., whether or not to adjust the threshold probability) and can also be used to make a determination whether or not to throttle the service request. In example 1400, a P_{win} that is greater than or equal to the threshold probability can be considered to satisfy the threshold probability such that the service request can be passed on the SSP 1406 for processing. Conversely, a P_{win} that is less than the threshold probability can be considered to not satisfy, or fail, the threshold probability such that the service request can be throttled 1408 (e.g., not passed on the SSP 1406 for processing).

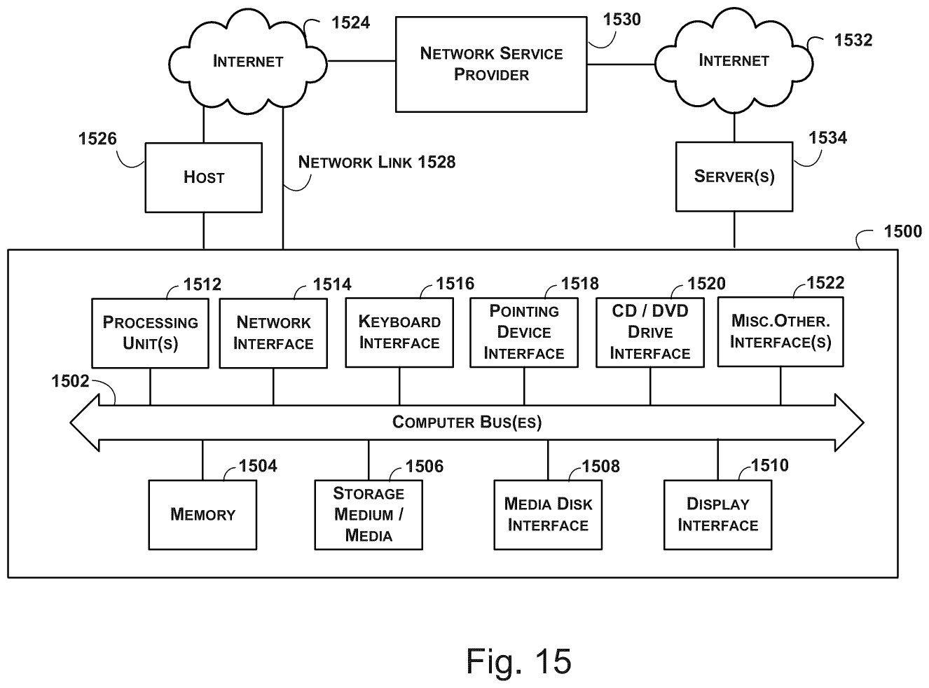

As shown in FIG. 15, internal architecture 1500 of a computing device(s), computing system, computing platform, user devices, set-top box, smart TV and the like includes one or more processing units, processors, or processing cores, (also referred to herein as CPUs) 1512, which interface with at least one computer bus 1502. Also interfacing with computer bus 1502 are computer-readable medium, or media, 1506, network interface 1514, memory 1504, e.g., random access memory (RAM), run-time transient memory, read only memory (ROM), media disk drive interface 1508 and/or CD/DVD Drive Interface 1520 as an interface for a drive that can read and/or write to media, display interface 1510 as interface for a monitor or other display device, keyboard interface 1516 as interface for a keyboard, pointing device interface 1518 as an interface for a mouse or other pointing device, and miscellaneous other interfaces 1522 not shown individually, such as parallel and serial port interfaces and a universal serial bus (USB) interface.

Memory 1504 interfaces with computer bus 1502 so as to provide information stored in memory 1504 to CPU 1512 during execution of software programs such as an operating system, application programs, device drivers, and software modules that comprise program code, and/or computer executable process steps, incorporating functionality described herein, e.g., one or more of process flows described herein. CPU 1512 first loads computer executable process steps from storage, e.g., memory 1504, computer readable storage medium/media 1506, removable media drive, and/or other storage device. CPU 1512 can then execute the stored process steps in order to execute the loaded computer-executable process steps. Stored data, e.g., data stored by a storage device, can be accessed by CPU 1512 during the execution of computer-executable process steps.

Persistent storage, e.g., medium/media 1506, can be used to store an operating system and one or more application programs. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 1528 typically provides information communication using transmission media through one or more networks to other devices that use or process the information. For example, network link 1528 may provide a connection through local network 1524 to a host computer 1526 or to equipment operated by a Network or Internet Service Provider (ISP) 1530. ISP equipment in turn provides data communication services through the public, worldwide packet-switching communication network of networks now commonly referred to as the Internet 1532.

A computer called a server host 1534 connected to the Internet 1532 hosts a process that provides a service in response to information received over the Internet 1532. For example, server host 1534 hosts a process that provides information representing video data for presentation at display 1510. It is contemplated that the components of system 1500 can be deployed in various configurations within other computer systems, e.g., host and server.

At least some embodiments of the present disclosure are related to the use of computer system 1500 for implementing some or all of the techniques described herein. According to one embodiment, those techniques are performed by computer system 1500 in response to processing unit 1512 executing one or more sequences of one or more processor instructions contained in memory 1504. Such instructions, also called computer instructions, software and program code, may be read into memory 1504 from another computer-readable medium 1506 such as storage device or network link. Execution of the sequences of instructions contained in memory 1504 causes processing unit 1512 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through at least one communications interface carry information to and from computer system 1500. Computer system 1500 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 1502 as it is received, or may be stored in memory 1504 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
receiving, at a computing device, a request for service directed to an online service provider;
determining, via the computing device, a feature vector for the received service request, the feature vector determination comprising identifying information associated with the request and a response of the service provider, the feature vector being based on the request and response information;
analyzing, via the computing device, the received request using a trained outcome prediction model and the feature vector, and determining a win probability based on the analysis, the win probability indicating a likelihood of a predefined outcome in connection with the service request and the service provider's response;
making, via the computing device, a request throttling determination based on the win probability and a threshold probability; and
managing, via the computing device, the service request in connection with the service provider based on the request throttling determination.

2. The method of claim 1, managing the service request further comprising:
causing, via the computing device, the service provider to generate the response to the service request where the request throttling determination indicates that the win probability satisfies the threshold probability.

3. The method of claim 1, managing the service request further comprising:
causing, via the computing device, the service provider to forego generating the response to the service request where the request throttling determination indicates that the win probability fails to satisfy the threshold probability.

4. The method of claim 1, managing the service request further comprising:
causing, via the computing device, the service provider to deprioritize generating the response to the service request where the request throttling determination indicates that the win probability fails to satisfy the threshold probability.

5. The method of claim 1, further comprising:
generating, via the computing device, a training dataset based on a corpus of unthrottled service request traffic representing past negative and positive service request outcomes; and
training, via the computing device, using the training dataset, the outcome prediction model to determine the win probability indicating a likelihood of a predefined outcome in connection with the service request and the service provider's response.

6. The method of claim 5, wherein a training data instance of the training dataset comprises a feature vector generated for a respective service request of the corpus of unthrottled service request traffic and a label indicating whether or not the service request resulted in the predefined outcome.

7. The method of claim 5, wherein the respective service request's feature vector comprises information associated with the respective service request and information associated with the respective service request's response.

8. The method of claim 1, determining a feature vector for the received service request further comprising:
determining, via the computing device, a first feature vector based on a set of features determined for the received service request;
determining, via the computing device, a second feature vector based on a set of features determined for a user; and
determining, via the computing device, the feature vector for the received service request based on the first and second feature vectors.

9. The method of claim 1, further comprising:
incrementally training, via the computing device, the threshold probability using historical information comprising a number of win probabilities determined for a corresponding number of received service requests.

10. The method of claim 9, wherein an online percentage estimation (OPE) mechanism is used with the historical information to incrementally train the threshold probability.

11. The method of claim 10, wherein the OPE mechanism is a Quantile Regression (QR) approach.

12. The method of claim 10, wherein the OPE mechanism is a t-Digest approach.

13. The method of claim 1, the service request comprises a request for content, the response comprising content responsive to the service request.

14. The method of claim 13, wherein the service provider is a Supply-Side-Platform (SSP) service provider, the service request is received from a publisher of a website and comprises a request for content for a page of the website, and the predefined outcome comprises inclusion of the requested content in the page published to at least one end user of the website.

15. The method of claim 13, wherein the requested content is advertising content.

16. A non-transitory computer-readable storage medium tangibly encoded with computer-executable instructions that when executed by a processor associated with a computing device perform a method comprising:
receiving a request for service directed to an online service provider;
determining a feature vector for the received service request, the feature vector determination comprising identifying information associated with the request and a response of the service provider, the feature vector being based on the request and response information;
analyzing the received request using a trained outcome prediction model and the feature vector, and determining a win probability based on the analysis, the win probability indicating a likelihood of a predefined outcome in connection with the service request and the service provider's response;
making a request throttling determination based on the win probability and a threshold probability; and
managing the service request in connection with the service provider based on the request throttling determination.

17. The non-transitory computer-readable storage medium of claim 16, managing the service request further comprising:
causing the service provider to generate the response to the service request where the request throttling determination indicates that the win probability satisfies the threshold probability.

18. The non-transitory computer-readable storage medium of claim 16, managing the service request further comprising:
causing the service provider to forego generating the response to the service request where the request throttling determination indicates that the win probability fails to satisfy the threshold probability.

19. The non-transitory computer-readable storage medium of claim 16, managing the service request further comprising:
causing the service provider to deprioritize generating the response to the service request where the request throttling determination indicates that the win probability fails to satisfy the threshold probability.

20. A computing device comprising:
a processor; and
a non-transitory storage medium for tangibly storing thereon program logic for execution by the processor, the program logic comprising:
receiving logic executed by the processor for receiving a request for service directed to an online service provider;
determining logic executed by the processor for determining a feature vector for the received service request, the feature vector determination comprising identifying information associated with the request and a response of the service provider, the feature vector being based on the request and response information;
analyzing logic executed by the processor for analyzing the received request using a trained outcome prediction model and the feature vector, and determining a win probability based on the analysis, the win probability indicating a likelihood of a predefined outcome in connection with the service request and the service provider's response;
making logic executed by the processor making a request throttling determination based on the win probability and a threshold probability; and
managing logic executed by the processor managing the service request in connection with the service provider based on the request throttling determination.
